(19) United States
(12) Patent Application Publication
(10) Pub. No.: US 2016/0109192 A1
(43) Pub. Date: Apr. 21, 2016

(54) INTERIOR HEAT EXCHANGER

(71) Applicant: Sanden Holdings Corporation, Isesaki-shi, Gunma (JP)

(72) Inventor: Yuuichi MATSUMOTO, Isesaki-shi, Gunma (JP)

(73) Assignee: Sanden Holdings Corporation, Isesaki-shi, Gunma (JP)

(21) Appl. No.: 14/893,610

(22) PCT Filed: May 22, 2014
(86) PCT No.: PCT/JP2014/063603

§ 371 Date: Nov. 24, 2015

(30) Foreign Application Priority Data
May 24, 2013 (JP) 2013-110297

(51) Int. Cl. F28F 9/02

(52) U.S. Cl. CPC F28F 9/02

(57) ABSTRACT

To provide a counter-flow type interior heat exchanger capable of reducing variation in outlet air temperature during heating, and capable of reducing heat exchange with blown air and reducing pressure loss generated when a gas refrigerant passes during cooling, to ensure cooling performance. A heat exchange region of a first tube group 103Au of a first heat exchanger disposed downstream in an air blowing direction and a heat exchange region of a fourth tube group 103Bd of a second heat exchanger disposed upstream in the air blowing direction are made to be larger (are imparted with a larger number of tubes) than a heat exchange region of a second tube group 103Ad of the first heat exchanger and a heat exchange region of the fourth tube group 103Bd of the second heat exchanger, and refrigerant channel areas of the first and second tube groups (total sectional area of the tube groups) are set to be larger than a sectional area of a refrigerant introduction pipe 110.

### TECHNICAL FIELD

The present invention relates to an interior heat exchanger that functions as a condenser in a heat pump device such as a vehicular air conditioner.

### BACKGROUND ART

In a heat pump type air conditioner for a vehicle, in an interior heat exchanger (condenser) disclosed in Patent Document 1, on each of both sides of a tube group including a plurality of refrigerant flow tubes arranged to be parallel, a header is connected to communicate with the tube group. A refrigerant introduction pipe and a refrigerant discharge pipe are connected to one header, and an inner portion of this header is divided into a refrigerant introduction pipe connection side and a refrigerant discharge pipe connection side. In this way, a refrigerant, which has introduced into the refrigerant introduction pipe connection side space from the refrigerant introduction pipe, flows through a part of the tube group communicating with the refrigerant introduction pipe connection side space and flows into the other header, and then, the refrigerant flows into the remaining part of the tube group, so as to be introduced into the refrigerant discharge pipe connection side space and discharged from the refrigerant discharge pipe.

In this way, variation in temperature of outlet air has been reduced by inverting a flow direction of a refrigerant and by adjusting the number of tubes, lengths of the tubes, and the like.

### REFERENCE DOCUMENT LIST

### Patent Document

Patent Document 1: Japanese Patent Application Laid-open Publication No. 2012-172850

### SUMMARY OF THE INVENTION

### Problems to be Solved by the Invention

However, the interior heat exchanger disclosed in Patent Document 1 is used in a range in which a supercooling temperature (supercooling degree) is 25° C. or less, and if the interior heat exchanger is used under a cryogenic environment in which supercooling further is required, variation in outlet air temperature (temperature of air blown from a heat exchanger) might increase (refer to FIG. 6 of Patent Document 1). For example, under an environment in which the outside air temperature is −10° C. or less, it is necessary to increase condensing pressure by increasing a supercooling temperature of the interior heat exchanger (condenser) and increase to a condensing temperature at which a desired heating feeling can be obtained, and there might be a problem in that the interior heat exchanger disclosed in Patent Document 1 is unlikely to be used in an operation region in which the variation in outlet air temperature easily increases.

Meanwhile, in a heat pump for a vehicle, when a condenser for heating is disposed in an interior air blowing path, there may be considered a method in which an air introduction port thereof is closed during cooling so that heat exchange with air is almost not performed and a refrigerant is caused to pass therethrough in a gas state.

In this method, costs can be reduced, compared to a structure in which a refrigerant bypasses an interior heat exchanger during cooling. However, it is necessary to reduce a pressure loss generated when a high temperature and high pressure gas passes as it is during cooling.

The present invention is made in consideration of these problems, and an object thereof is to provide an interior heat exchanger (condenser) capable of reducing variation in outlet air temperature of the interior heat exchanger during heating, and capable of reducing a pressure loss generated when a refrigerant in a gas state passes during cooling, to maintain improved cooling performance.

### Means for Solving the Problems

According to an aspect of the present invention, there is provided an interior heat exchanger including a pair of heat exchangers, each having a tube group including a plurality of refrigerant flow tubes extending in a vertical direction and arranged to be parallel, an upper end portion and a lower end portion of the tube group being connected to communicate with an upper header and a lower header, the headers extending in a horizontal direction, wherein the first heat exchanger disposed on an upstream side in a refrigerant flow direction is disposed on a downstream side in a direction of air blown to a cabin, and the second heat exchanger disposed on a downstream side in the refrigerant flow direction is disposed on an upstream side in the air blowing direction, wherein the header of the first heat exchanger and the header of the second heat exchanger, adjacent to the header of the first heat exchanger, are connected to communicate with each other, wherein the interior heat exchanger is configured as a counter-flow type so that the interior heat exchanger functions as a condenser capable of performing a supercooling operation at a temperature exceeding 35° C. during heating, whereas the interior heat exchanger allows a refrigerant in a gas state to pass through during cooling, wherein an inner portion of at least one of the headers of the first heat exchanger and the second heat exchanger is divided into horizontally arranged spaces, the tube group of each heat exchanger is defined to be heat exchange regions so that the refrigerant flow direction is inverted between the adjacent tube groups, and in the second heat exchanger, a heat exchange region on the most downstream side in the refrigerant flow direction is set to be larger than a heat exchange region on an upstream side in the refrigerant flow direction, wherein in the first heat exchanger, a refrigerant channel area of each heat exchange region is set to be larger than a sectional area of a refrigerant introduction pipe connected to the first heat exchanger.

### Effects of the Invention

According to the interior heat exchanger of the present invention, the following effects can be obtained.

When a high level supercooling operation at a supercooling temperature exceeding 35° C. is performed, although a supercooled, low-temperature region in the second heat exchanger increases, the temperature change due to heat exchange with the blown air can be gentle since a plurality of heat exchange regions is defined in each of the first heat exchanger and the second heat exchanger, and thus, an increase of the supercooling region can be reduced, compared with a case in which a plurality of heat exchange regions is not defined.

In addition, since, in the second heat exchanger, the heat exchange region on the most downstream side is set to be larger than the heat exchange region on the upstream side, it is possible to have the supercooling region formed within the heat exchange region on the most downstream side, or to limit the supercooling region to a smaller region even when the supercooling region increases and extends over the heat exchange region on the upper stream side.

Since the supercooling region greatly influences the temperature of blown air passing the supercooling region, it is possible to reduce variation in outlet air temperature by reducing the supercooling region, as described above.

On the other hand, during a cooling operation, although, in particular, a high-temperature and high-pressure gas refrigerant passes through the first heat exchanger on the upstream side in the refrigerant flow direction, it is possible to maintain improved cooling performance of a heat pump system by reducing an increase in flow resistance, since the refrigerant channel areas of the tube group (total sectional area of the tube group) in each of the heat exchange regions are set to be larger than the sectional area of the refrigerant introduction pipe.

### BRIEF DESCRIPTION OF THE DRAWINGS

FIG. 1 is a diagram illustrating a flow of a refrigerant during heating in a refrigerant circuit in a vehicular air conditioner provided with a vehicle interior heat exchanger according to the present invention.

FIG. 2 is a diagram illustrating a flow of the refrigerant during cooling in the refrigerant circuit in the vehicular air conditioner.

FIG. 3 is a front view when the vehicle interior heat exchanger is viewed from a downstream side in a blowing direction of air.

FIG. 4 is a side view when viewed from A of FIG. 3.

FIG. 5 is a cross-sectional view taken along with a line B-B of FIG. 3.

FIG. 6 is a side view when viewed from C of FIG. 3.

FIGS. 7A and 7B are a plan view and a front view illustrating a connection member by which a pair of headers disposed on a lower end portion of the vehicle interior heat exchanger is connected to each other to communicate with each other.

FIG. 8 is a schematic perspective view illustrating a flow of the refrigerant in the vehicle interior heat exchanger.

FIG. 9 is a diagram comparing a temperature difference in outlet air temperature of a four-pass type interior heat exchanger, functioning as a condenser during heating, with that of a two-pass type interior heat exchanger.

FIG. 10 is a diagram of a heating COP ratio of four-pass type interior heat exchangers with different sizes of heat exchange regions of the first pass to the fourth pass, compared with that of the two-pass type interior heat exchanger.

FIG. 11 is a diagram of an outlet air temperature difference ratio of the four-pass type interior heat exchangers with different sizes of the heat exchange regions of the first pass to the fourth pass, compared with that of the two-pass type interior heat exchanger.

FIG. 12 is a diagram of a cooling COP ratio of the four-pass type interior heat exchangers with different sizes of the heat exchange regions of the first pass to the fourth pass, compared with that of the two-pass type interior heat exchanger.

FIG. 13 is a graph illustrating the relationship between a fourth pass ratio and variation in outlet air temperature during heating.

FIG. 14 is a graph illustrating the relationship between a refrigerant channel area of the first heat exchanger and COP during heating and cooling.

### MODE FOR CARRYING OUT THE INVENTION

An embodiment of the present invention will be described below.

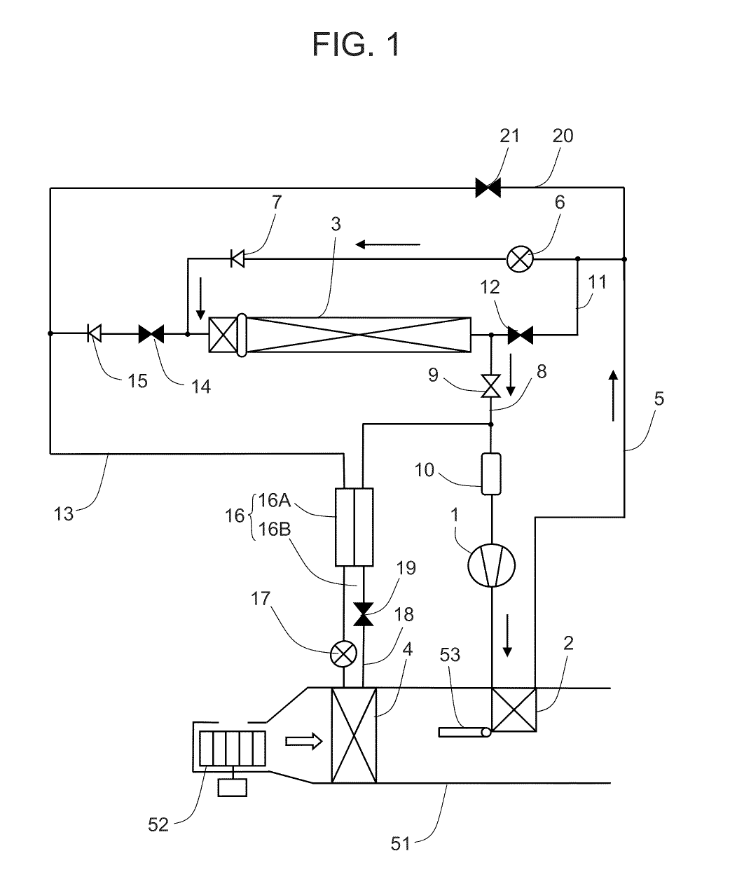

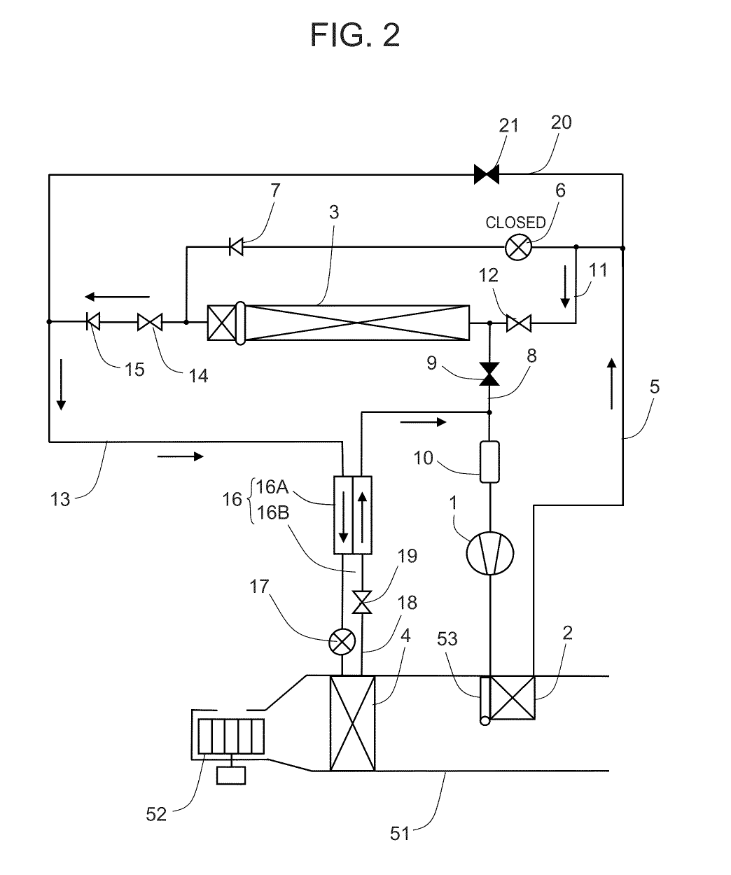

FIGS. 1 and 2 are schematic views of a refrigerant circuit in a heat pump type vehicular air conditioner provided with an interior heat exchanger (condenser) according to the present invention. However, the refrigerant circuit in which the interior heat exchanger of the present invention can be used is not limited thereto.

The air conditioner is configured to include a compressor 1, a first vehicle interior heat exchanger 2 disposed on a downstream side of an air blowing path 51 in a cabin, a vehicle exterior heat exchanger 3 disposed outside the cabin, and a second vehicle interior heat exchanger 4 disposed on an upstream side of the air blowing path 51 in the cabin.

A fan 52 is disposed on an upstream end portion of the air blowing path 51, and a damper 53 that freely opens and closes a ventilation opening of the first vehicle interior heat exchanger 2 is mounted on the ventilation opening.

A first expansion valve 6 and a first check valve 7 are provided in the middle of a first refrigerant pipe 5 extending from a refrigerant discharge port of the compressor 1 to the vehicle exterior heat exchanger 3 via the first vehicle interior heat exchanger 2. A first on-off valve 9 and an accumulator 10 are provided in the middle of a second refrigerant pipe 8 extending from the vehicle exterior heat exchanger 3 to a refrigerant inlet port of the compressor 1.

A third refrigerant pipe 11 connects the downstream side of the first expansion valve 6 of the first refrigerant pipe 5 with a portion between the exterior heat exchanger 3 and the first on-off valve 9, and a second on-off valve 12 is provided in the third refrigerant pipe 11. Here, when the second on-off valve 12 is open, since the first expansion valve 6 has greater channel resistance than that of the second on-off valve 12, the first expansion valve 6 is substantially closed. However, the first expansion valve 6 may be forcibly closed. Accordingly, the first expansion valve 6 and the second on-off valve 12 are selectively open.

A fourth refrigerant pipe 13 that is branched from the downstream side of the first check valve 7 of the first refrigerant pipe 5 and reaches the second vehicle interior heat exchanger 4 is provided, and a third on-off valve 14, a second check valve 15, a high-temperature portion 16A of an internal heat exchanger 16, and a second expansion valve 17 are provided in the fourth refrigerant pipe 13.

A fifth refrigerant pipe 18 connects the second vehicle interior heat exchanger 4 with a portion between the first on-off valve 9 and the accumulator 10, and a fourth on-off valve 19 and a low-temperature portion of the internal heat exchanger 16 are provided in the fifth refrigerant pipe 18. In the internal heat exchanger 16, heat exchange is performed between a high-temperature refrigerant passing through the high-temperature portion 16A and a low-temperature refrigerant passing through the low-temperature portion 16B.

A sixth refrigerant pipe 20 extending from the upstream side of the first expansion valve 6 of the first refrigerant pipe 5 to the downstream side of the check valve 15 of the fourth refrigerant pipe 13 is provided, and a fifth on-off valve 21 is provided in the sixth refrigerant pipe 20.

Next, an outline during each operation of the air conditioner will be described.

During heating, the damper 53, the first expansion valve 6, and the first on-off valve 9 are open, and the second on-off valve 12, the third on-off valve 14, the fourth on-off valve 19, and the fifth on-off valve 21 are closed.

As illustrated in FIG. 1, a high-temperature and high-pressure gas refrigerant compressed by the compressor 1 flows into the first vehicle interior heat exchanger 2, undergoes heat exchange (heat radiation) with air blown from the fan 52, and is condensed and liquefied. The air is heated by this heat exchange. The heated air is blown into the cabin, and heats the inner portion of the cabin.

Then, the liquid refrigerant is decompressed via the first expansion valve 6, is brought into a gas-liquid mixed state, and flows into the vehicle exterior heat exchanger 3 via the first check valve 7. In the vehicle exterior heat exchanger 3, a period in which the refrigerant undergoes heat exchange (heat absorption) with outside air and is vaporized (gasified) and then the refrigerant is returned to a suction port of the compressor 1 via the first on-off valve 9 so as to be compressed is repeated.

During cooling, the second on-off valve 12, the third on-off valve 14, and the fourth on-off valve 19 are open, and the damper 53, the first expansion valve 6, the first on-off valve 9, and the fifth on-off valve 21 are closed.

As illustrated in FIG. 2, although the refrigerant compressed by the compressor 1 passes through the first vehicle interior heat exchanger 2, heat exchange (cooling) between the blown air and the refrigerant is almost not performed, since the damper 53 is closed and air blowing to the first vehicle interior heat exchanger 2 is interrupted, and thus, the refrigerant flows out in a high temperature and high pressure gas state, and flows into the vehicle exterior heat exchanger 3 via the second on-off valve 12.

The vehicle exterior heat exchanger 3 functions as a condenser, performs heat exchange (heat radiation) with outside air, and condenses and liquefies the gas refrigerant. This liquid refrigerant reaches the second expansion valve 17 via the third on-off valve 14, the check valve 15, and the low-temperature portion 16A of the internal heat exchanger 16, and is decompressed by the second expansion valve 17, so that the liquid refrigerant is brought into a gas-liquid mixed state, and flows into the second vehicle interior heat exchanger 4. In the second vehicle interior heat exchanger 4, the refrigerant undergoes heat exchange (heat absorption) with the air blown from the fan 52, and the refrigerant is gasified. The air cooled by this heat exchange is blown into the cabin, and cools the cabin.

In addition, during dehumidification, simply, by opening the damper 53 in the state during the cooling as described above, the air which has been cooled and condensed by the second vehicle interior heat exchanger 4 and in which water has been reduced is reheated by the first vehicle interior heat exchanger 2 downstream, and it is possible to blow air having a lower relative humidity into the cabin. In addition, in order to improve cooling and dehumidification functions performed by the second vehicle interior heat exchanger 4, a flow rate of the refrigerant supplied to the second vehicle interior heat exchanger 4 may be increased by opening the fifth on-off valve 21 provided in the sixth refrigerant pipe 20.

The first vehicle interior heat exchanger 2 operated as a condenser during heating and configured such that the refrigerant flows without performing heat exchange with air during cooling, as described above, is configured as follows.

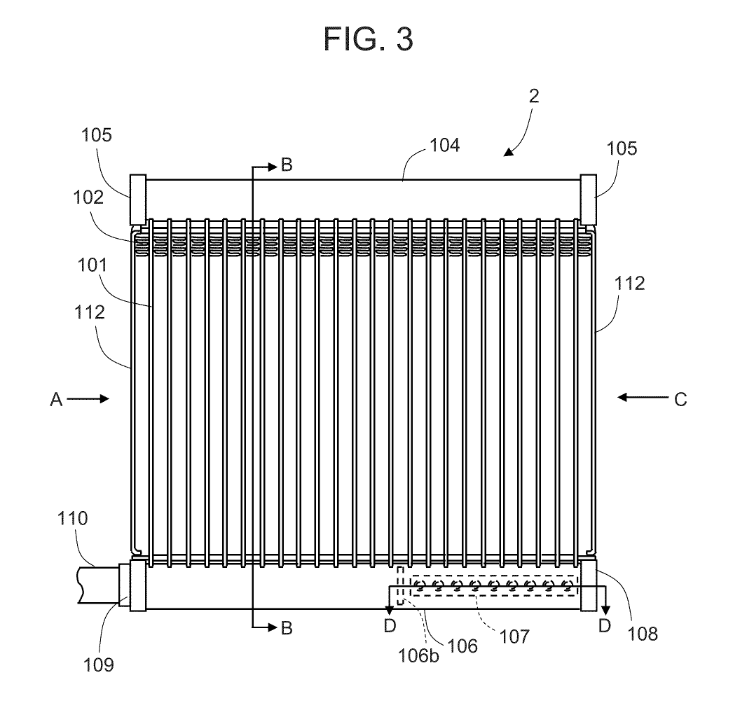

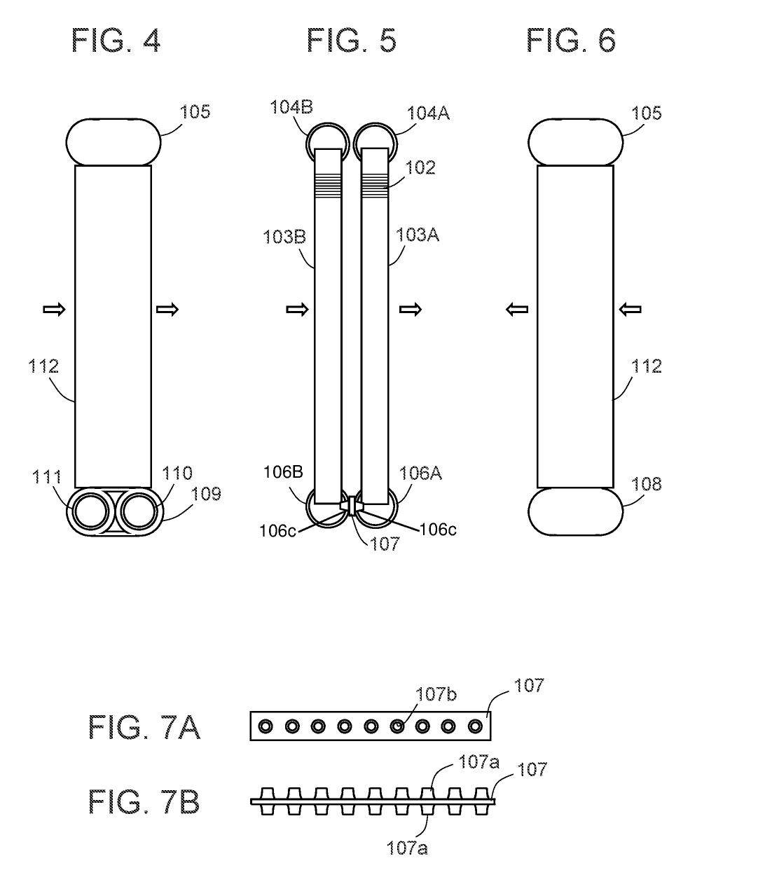

FIG. 3 is a front view when the second vehicle interior heat exchanger 2 is viewed from a downstream side in a blowing direction of air, FIG. 4 is a view when viewed from A of FIG. 3, FIG. 5 is a cross-sectional view taken along with a line B-B of FIG. 3, and FIG. 6 is a side view when viewed from C of FIG. 3.

A plurality of refrigerant flow tubes 101 having a flat channel cross-section and extending in a vertical direction is arranged to be parallel, with a corrugated fin 102 (only the upper portion is illustrated in the drawing) disposed between the refrigerant flow tubes 101, and forms a pair of tube groups 103A and 103B. The tube groups 103A and 103B face each other and are arranged in two rows on the upstream side and the downstream side with a gap in the air blowing direction of the air blowing path 51. Each refrigerant flow tube 101 and the corrugated fin 102 are fixed to each other by brazing or the like.

A pair of cylindrical headers extending in a horizontal direction is disposed on both upper and lower sides of each of the tube groups 103A and 1038 arranged in two rows.

Each of a pair of headers 104A and 1048 disposed on the upper sides of the tube groups 103A and 1038 arranged in two rows includes a plurality of holes into which one end portion (upper end portion) of the refrigerant flow tubes 101 of each tube group is inserted, and the upper end portion of each of the tube groups 103A and 103B is inserted into the corresponding hole of the headers 104A and 104B and is fixed to the headers 104A and 104B by brazing.

In addition, both open ends of the upper headers 104A and 1048 are sealed by cover members 105, and the cover members 105 are fixed thereto by brazing.

Similarly to the headers 104A and 1048, each of a pair of headers 106A and 1068 disposed on the lower sides of the refrigerant flow tube 101 includes a plurality of holes into which the lower end portions of the refrigerant flow tubes 11 of each of the tube groups 103A and 1038 are inserted, the lower end portion of each of the tube groups 103A and 103B is inserted into the corresponding hole of the headers 106A and 1068 and is fixed to the headers 106A and 1068 by brazing.

One (at the right side of the drawing) open end of the lower headers 106A and 1068 is sealed by a cover member 108, and the cover member 108 is fixed thereto by brazing.

A pipe joint 109 having an open center portion is fixed to the other (at the left side of the drawing) open end of each of the headers 106A and 106B by brazing, a refrigerant inlet pipe 110 is fixed to the header 106A side pipe joint 109 by brazing, and a refrigerant outlet pipe 111 is fixed to the header 106B side pipe joint 109 by brazing.

Each of internal spaces of the headers 106A and 106B is divided into two sections by a disk-shaped partition member 106b in the middle of the space in an axial direction. The partition member 106b is fixed to an inner wall of each of the pair of headers 106A and 106B by brazing.

Here, each of the two partition members 106b is disposed at a position farther away from the refrigerant inlet pipe 110 and the refrigerant outlet pipe 111 than a center position in the internal space.

In addition, in the portions divided by the partition members 106b of the headers 106A and 106B and located on the opposite side of the refrigerant inlet pipe 110 and the refrigerant outlet pipe 111 (at the right side of the drawing), a plurality of (nine in the drawing) boss through-holes 106c is formed on each of internal walls facing each other.

In addition, as illustrated in FIGS. 7A and 7B, a connection member 107, in which boss portions 107a having communication holes 107b inside the boss portions 107a are protruded, is formed on both sides on a flat portion of a plate-shaped member, and as illustrated in FIG. 5, the boss portions of the connection member 107 penetrate the boss through-holes 106c of the headers 106A and 106B and are fixed to headers 106A and 106B by brazing.

For example, the boss portions 107a of the connection plate 107 may be formed by preparing a pair of plate members, each having protruding portions formed by burring so as to protrude from one side surface of the plate member, and then by fixing the plate members to each other by brazing or the like in a state in which the plate members face the opposite directions. Alternatively, the boss portions 107a may be formed by a well-known method in which first burring is performed so that protruding portions protrude toward one side surface of one plate member, and then additional burring is performed in a reverse direction so that protruding portions protrude from the opposite side.

In addition, as illustrated in FIG. 3, reinforcing plates 112 are fixed to both end portions in overlapping directions of the tube groups 103A, 103B, 106A, and 106B.

In this way, in the first vehicle interior heat exchanger 2, the heat exchanger (first heat exchanger) on the upstream side in the refrigerant flow direction, which is disposed on the downstream side in the air blowing direction of the air blowing path, and the heat exchanger (second heat exchanger) on the downstream side in the refrigerant flow direction, which is disposed on the upstream side in the air blowing direction, are connected to each other so as to communicate with each other via communications holes.

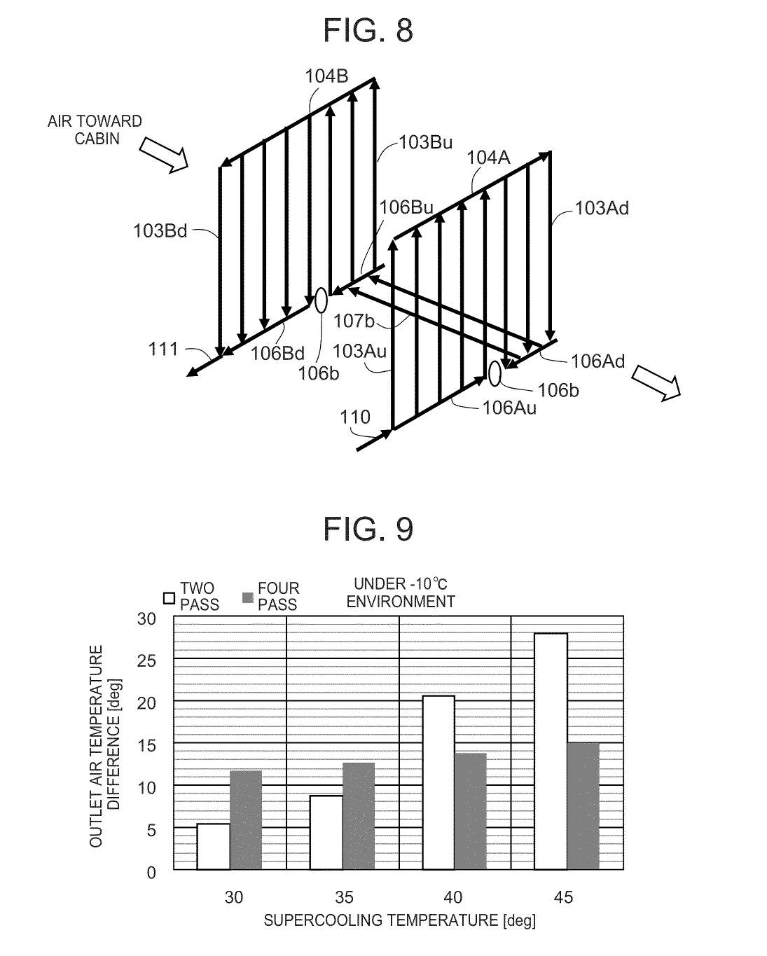

A flow of a refrigerant of the first vehicle interior heat exchanger 2 having the above-described configuration is illustrated by arrows in FIG. 8.

The refrigerant flows from the refrigerant inlet pipe 110 into the header 106A disposed on the lower side of the first heat exchanger, flows into the plurality of (14 in FIG. 3) refrigerant flow tubes 101 (first tube group 103Au) through lower end openings thereof, which are open to a first header space 106Au positioned before the partition plate 106b, and flows upward through the first tube group 103Au.

In addition, after the refrigerant flows into the upper header 104A through the upper end openings of the first tube group 103Au, the refrigerant flows into the plurality of (10 in FIG. 3) refrigerant flow tubes 101 (second tube group 103Ad), which are positioned behind, through upper end openings of the second tube group 103Ad, and flows downward through the second tube group 103Ad.

Moreover, the refrigerant flows through the lower end openings of the second tube group 103Ad into a second header space 106Ad, which is positioned behind the partition plate 106b.

Sequentially, the refrigerant flows into a third header space 106Bu positioned behind the partition plate 106b of the header 106B of the second heat exchanger adjacent to the first heat exchanger through the communication holes 107b of the boss portions 107a of the connection member 7, the communication holes 107b being open to the second header space 106Ad.

The refrigerant flows into the plurality of (10 in FIG. 3) refrigerant flow tubes 101 (third tube group 103Bu) through the lower end openings of the third tube group 103Bu, which are open to the third header inner space 106Bu, and flows upward through the third tube group 103Bu.

In addition, after the refrigerant flows into the header 104B through the upper end openings of the third tube group 103Bu, the refrigerant flows downward through the plurality of (14 in FIG. 3) refrigerant flow tubes 101 (fourth tube group 103Bd) positioned before, through the upper end openings of the fourth tube group 103Bd.

In addition, the refrigerant flows into a fourth header space 106Bd positioned before the partition plate 106b through the lower end openings of the fourth tube group 103Bd, and flows out from the refrigerant outlet pipe 111.

When the vehicle interior heat exchanger 2 functions as a condenser during heating, the refrigerant undergoes heat exchange with blown air, which flows while coming into contact with an outer surface of each tube 101, while the refrigerant passes through each of the refrigerant flow tubes 101 of the two tube groups 103A and 1038, as described above, heat of the refrigerant is radiated, the refrigerant undergoes heat exchange with the corrugated fin 102 cooled by the blown air coming into contact with the outer surface, and heat of the refrigerant is radiated. Accordingly, the refrigerant can be effectively cooled, condensed, and liquefied.

Here, like the present embodiment, a heat exchanger, in which four heat exchange regions defined by first to fourth tube groups (first to fourth passes) in which the refrigerant flow directions are made to turn (inverted) are formed, is referred to as a four-pass type heat exchanger. Meanwhile, a heat exchanger which includes two heat exchange portions and in which a refrigerant from a refrigerant inlet pipe simultaneously flows through all tube groups of a first heat exchanger, moves to a second heat exchanger, simultaneously flows through all tube groups of the second heat exchanger, and flows out from a refrigerant outlet pipe, is referred to as a two-pass type heat exchanger.

FIG. 9 is a diagram comparing a temperature difference (a difference between the highest temperature of the outlet air temperatures and the lowest temperature of the outlet air temperatures in all heat exchange regions) of an outlet air temperature of the four-pass type interior heat exchanger functioning as a condenser during heating with a temperature difference of an outlet air temperature of the two-pass type interior heat exchanger. Here, in the four-pass type interior heat exchanger, the sizes of the four heat exchange regions (sectional areas in directions perpendicular to the air blowing direction) are set so as to be equal to one another.

When an operation is performed at supercooling temperatures of 30° C. and 35° C., a supercooling region in which a liquid refrigerant condensed in the second heat exchanger disposed on the downstream side exists decreases. However, when a high level supercooling operation at supercooling temperatures of 40° C. and 45° C. is performed, the supercooling region increases. Here, since the refrigerant is in a liquid state in the supercooling region, heat exchange efficiency between the refrigerant and the blown air increases, and compared to other regions, influences applied to the outlet air temperature of the blown air which passes through the supercooling region and undergoes heat exchange with the supercooling region increases. As a result, the difference between the outlet air temperatures increases as the supercooling region increases.

When an operation is performed at supercooling temperatures of 30° C. and 35° C. in which the supercooling region decreases, the difference between the outlet air temperatures of the four-pass type interior heat exchanger is greater than the difference between the outlet air temperatures of the two-pass type interior heat exchanger. However, an improved level such as 15° C. or less is maintained.

Meanwhile, in order to achieve an improved heating function under a low-temperature environment of −10° C. or less, it is necessary to perform a high level supercooling operation at supercooling temperatures of 40° C. and 45° C. In this case, since the two-pass type interior heat exchanger has a shorter flow path of the refrigerant, compared to that of the four-pass type interior heat exchanger, in two-pass type interior heat exchanger, the temperature change of the refrigerant increases, and the major portion of the heat exchange region of the second heat exchanger becomes the supercooling region. Accordingly, in two-pass type interior heat exchanger, the difference of the outlet air temperatures greatly exceeds 15° C., and discomfort might be imparted to a human body.

On the other hand, since the four-pass type interior heat exchanger has a longer flow path of the refrigerant, in four-pass type interior heat exchanger, the temperature change of the refrigerant can be gentle, and an increase in supercooling region can be reduced and the supercooling region can be reduced to an extent slightly exceeding the half of the heat exchange region of the second heat exchanger. As a result, an increase in difference between the outlet air temperatures is able to be reduced, and an improved level of 15° C. or less can be maintained.

In addition, in the present embodiment, the heat exchange region of the fourth pass (fourth tube group) of the four-pass type interior heat exchanger is set to be larger than the heat exchange region of the third pass (third tube group).

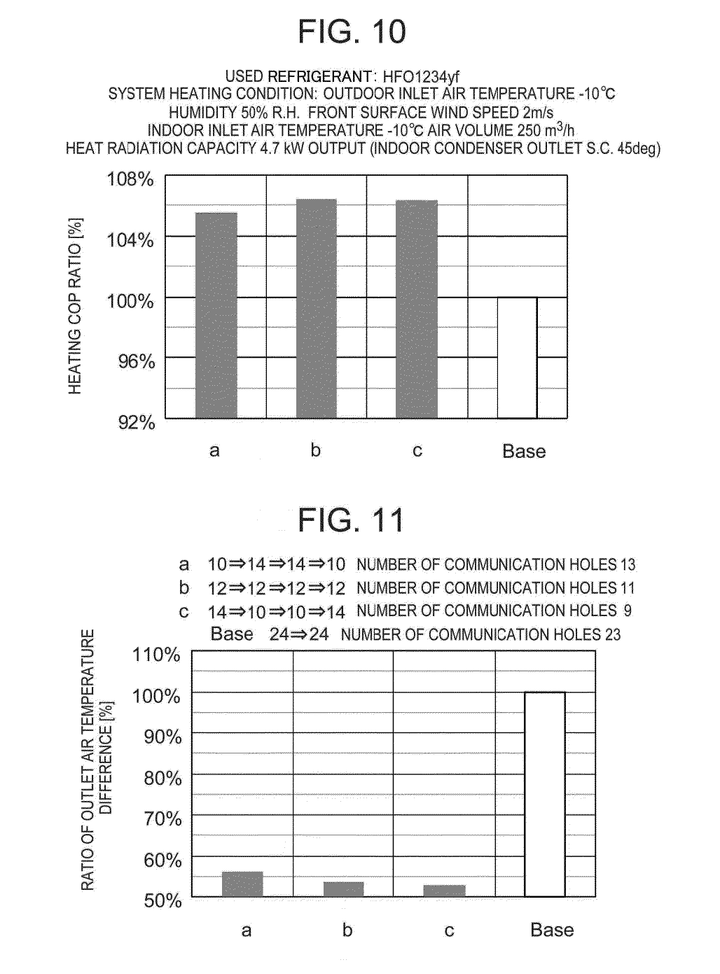

FIGS. 10 to 12 illustrate ratios of various state quantities of four-pass type interior heat exchangers with different sizes of the heat exchange regions of the first pass to the fourth pass, compared with those of the two-pass type interior heat exchanger, that is, a heating COP ratio, an outlet air temperature difference ratio, and a cooling COP ratio. Heating conditions and cooling conditions are illustrated in the drawings, and during heating, the supercooling operation at 45° C. is performed.

A symbol “a” indicates a case in which the heat exchange region of the third pass (second pass) is set to be larger than the heat exchange region of the fourth pass (first pass), and specifically, a case in which the number of the tubes of the third pass (and second pass) is 14, and the number of the tubes of the fourth pass (and first pass) is 10.

A symbol “b” indicates a case in which the heat exchange regions of the first to fourth passes are set so as to be equal to each other, and specifically, a case in which the number of the tubes of each pass is 12.

A symbol “c” corresponds to the embodiment of the present invention, and indicates a case in which the heat exchange region of the fourth pass (=the heat exchange region of the first pass) is set to be larger than the heat exchange region of the fourth pass (=heat exchange region of the first pass), and specifically, a case in which the number of the tubes of the fourth pass (and the first pass) is 14, and the number of the tubes of the third pass (and second pass) is 10.

As illustrated in FIG. 10, regarding the heating COP ratio, the four-pass type interior heat exchangers a, b and c had improved results exceeding 5% or more, compared to the two-pass type interior heat exchanger.

As illustrated in FIG. 11, regarding the outlet air temperature difference ratio (advantages increase as the temperature difference ratio decreases), the four-pass type interior heat exchangers a, b and c had significantly decreased outlet air temperature difference ratios (b is also illustrated in FIG. 9), compared to the two-pass type interior heat exchanger, and particularly, the four-pass type interior heat exchanger c (the present embodiment) had a further decreased outlet air temperature difference ratio.

It is thought that this is because the refrigerant temperature at the fourth pass is gently decreased by setting the fourth pass, which is the most downstream side heat exchange region, to be larger than the third pass, so that the supercooling region becomes more likely to be formed within the fourth pass, and the total supercooling region is able to be reduced even when the supercooling region increases and extends over at least a part of the third pass located upstream of the fourth pass.

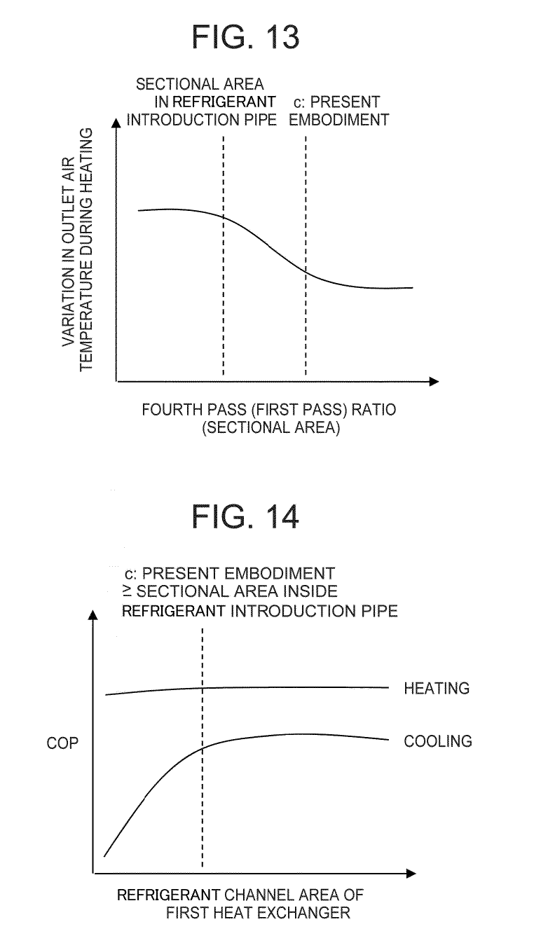

Here, as illustrated in FIG. 13, the outlet air temperature difference is able to decrease as the heat exchange region of the fourth pass increases. However, since the heat exchange region of the third pass relatively decreases, channel resistance increases when the refrigerant passes through the third pass in a gas state during a cooling operation of the system, and the cooling COP decreases.

Accordingly, in order to maintain improved cooling COP, it is necessary to adjust ratios of the heat exchange regions of the fourth pass and the third pass to ensure a refrigerant channel area. Moreover, in the first heat exchanger into which refrigerant gas having a higher temperature and a higher pressure than the refrigerant gas of the second heat exchanger flows and which is positioned on the upstream side in the refrigerant flow direction, it is necessary to ensure a refrigerant channel area capable of maintaining improved cooling COP.

FIG. 14 illustrates the relationship between the refrigerant channel area (the total sectional area of the tube group of the smaller one of the first pass and the second pass) of the first heat exchanger and COP. FIG. 14 illustrates that the COP is maintained to be substantially constant during heating, whereas, during cooling, in a case in which the refrigerant channel area is equal to or more than a sectional area of the refrigerant introduction pipe, improved COP is able to be obtained.

Specifically, in the present embodiment of c, the number of the tubes of each of the second pass and the third pass is set to 10, and the refrigerant channel area (the total sectional area of 10 tubes) is set so as to be equal to or more than the sectional area of the refrigerant introduction pipe 110.

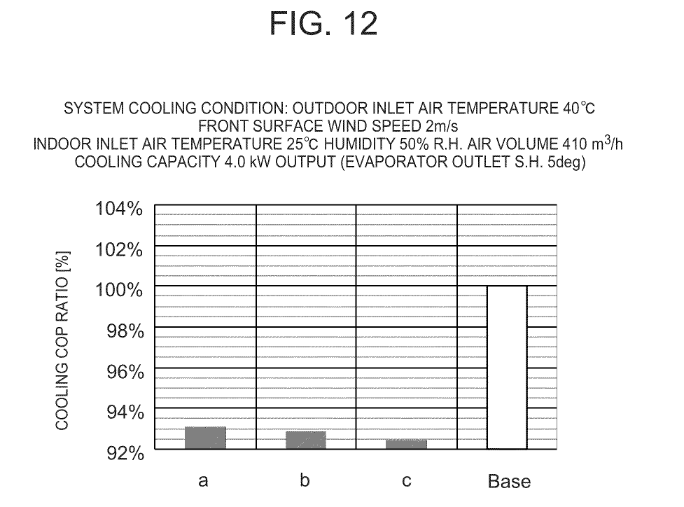

As a result, as illustrated in FIG. 12, the cooling COP ratio of c (the present embodiment) is less than the cooling COP ratios of a and b. However, regarding the cooling COP ratio c (the present embodiment), it is obvious that it is possible to ensure 92.5% with respect to the two-pass type interior heat exchanger and it is possible to maintain improved cooling performance of the system.

In addition, the ratios of the heat exchange regions of the first pass and the second pass of the first heat exchanger are not limited to the above-described embodiment. For example, each of the ratios may be set to 50% (the number of the tubes is 12). However, as the present embodiment, by matching the ratios of the heat exchange regions of the fourth pass and the first pass (the number of the tubes is 14 and 10), the entire first pass having the highest temperature and the entire fourth pass having the lowest temperature overlap each other, and it is possible to further decrease variation in the outlet air temperature.

In addition, for example, even when the connection position between the refrigerant introduction pipe and the refrigerant discharge pipe in a right hand drive vehicle and the connection position between the refrigerant introduction pipe and the refrigerant discharge pipe in a left hand drive vehicle are bilaterally symmetric in the air blowing direction, a common heat exchanger is able to be mounted in a state in which the right and left directions are changed from each other (the ratios of the heat exchange regions of the first pass to the fourth pass don't change), versatility is able to be obtained, and it is possible to decrease costs.

In addition, in general, since the shape of the heat exchanger is set so as to be horizontally long, it is possible to increase the number of tubes per each pass in the heat exchanger of the present embodiment in which the refrigerant flow tubes 101 are disposed in the vertical direction, compared to the heat exchanger of Patent Document 1 in which the refrigerant flow tubes are disposed in a horizontal direction, when the heat exchange regions are formed by the same number of passes. Accordingly, it is possible to reduce refrigerant flow resistance, and a decrease in system efficiency is able to be reduced.

### REFERENCE SYMBOL LIST

2 First vehicle interior heat exchanger
51 Air blowing path
53 Damper
101 Refrigerant flow tube
103A, 103B Tube group
103Au First tube group (first pass)
103Ad Second tube group (second pass)
103Bu Third tube group (third pass)
103Bd Fourth tube group (fourth pass)
104A, 104B Header
106A, 106B Header
106b Partition plate
106Au First header space
106Bu Third header space
106Bd Fourth header space
106Ad Second header space
107b Communication hole
110 Refrigerant introduction pipe
111 Refrigerant discharge pipe

1. An interior heat exchanger comprising a pair of heat exchangers, each having a tube group including a plurality of refrigerant flow tubes extending in a vertical direction and arranged to be parallel, an upper end portion and a lower end portion of the tube group being connected to communicate with an upper header and a lower header, the headers extending in a horizontal direction, wherein the first heat exchanger disposed on an upstream side in a refrigerant flow direction is disposed on a downstream side in a direction of air blown to a cabin, and the second heat exchanger disposed on a downstream side in the refrigerant flow direction is disposed on an upstream side in the air blowing direction, wherein the header of the first heat exchanger and the header of the second heat exchanger, adjacent to the header of the first heat exchanger, are connected to communicate with each other, wherein the interior heat exchanger is configured as a counter-flow type so that the interior heat exchanger functions as a condenser capable of performing a supercooling operation at a temperature exceeding 35° C. during heating, whereas the interior heat exchanger allows a refrigerant in a gas state to pass through during cooling,
wherein an inner portion of at least one of the headers of the first heat exchanger and the second heat exchanger is divided into horizontally arranged spaces, the tube group of each heat exchanger is defined to be heat exchange regions so that the refrigerant flow direction is inverted between the adjacent tube groups, and in the second heat exchanger, a heat exchange region on the most downstream side in the refrigerant flow direction is set to be larger than a heat exchange region on an upstream side in the refrigerant flow direction,
wherein in the first heat exchanger, a refrigerant channel area of each heat exchange region is set to be larger than a sectional area of a refrigerant introduction pipe connected to the first heat exchanger.

2. The interior heat exchanger according to claim 1,
wherein in the first heat exchanger, a heat exchange region on the most upstream side in the refrigerant flow direction is set to be larger than a heat exchange region on a downstream side in the refrigerant flow direction.

3. The interior heat exchanger according to claim 2,
wherein in each of the first heat exchanger and the second heat exchanger, the tube group is defined to be two heat exchange regions, wherein a size of the heat exchange region on the upstream side in the refrigerant flow direction in the first heat exchanger is set to be equal to a size of the heat exchange region on the downstream side in the refrigerant flow direction in the second heat exchanger, and a size of the heat exchange region on the downstream side in the refrigerant flow direction in the first heat exchanger is set to be equal to a size of the heat exchange region on the upstream side in the refrigerant flow direction in the second heat exchanger.

4. The interior heat exchanger according to claim 1,
wherein the interior heat exchanger is disposed in a path of air blown to the cabin in a vehicular air conditioner, a ventilation opening is open during heating, and the ventilation opening is closed during cooling.
